(19) United States
(12) Patent Application Publication
(10) Pub. No.: US 2020/0124843 A1
(43) Pub. Date: Apr. 23, 2020

(54) METHOD OF ADJUSTING A PLURALITY OF OPTICAL ELEMENTS ASSOCIATED WITH A LIGHT IMAGING MODULE

(71) Applicant: Xerox Corporation, Norwalk, CT (US)

(72) Inventor: Robert P. Herloski, Webster, NY (US)

(73) Assignee: Xerox Corporation, Norwalk, CT (US)

(21) Appl. No.: 16/165,442

(22) Filed: Oct. 19, 2018

(51) Int. Cl. G02B 27/00; G06F 17/50; B41J 2/47

(52) U.S. Cl. CPC G02B 27/0012; G06F 2217/16; B41J 2/47; G06F 17/5009

(57) ABSTRACT

Disclosed is a method of adjusting a plurality of optical elements associated with a printing system Laser Imaging Module (LIM). According to one exemplary embodiment, sensitivity analysis is performed on a computer model of the LIM system and an optical element alignment sequence is generated to minimize the number of optical element adjustments needed to achieve a predefined LIM performance.

### BACKGROUND

The present disclosure is directed to a printing system Laser Imaging Module (LIM) to form images on an imaging surface. More particularly, the present disclosure is directed to a compensation process associated with an optical system associated with an LIM.

Many laser diode applications require the collection and homogenization of the coherent light generated by a laser diode bar. In many optical systems associated with an LIM, there are numerous manufacturing tolerances that must be accommodated for in the final design. For example, the projection optics portion (as described in greater detail below) of a single image beam bath (IBP) of an LIM includes 170+ different tolerances associated with a plurality of optical elements and 20+ output metrics. For example and without limitation, the projection optics for a LIM including 15 IBPs has 2700+ tolerances and 300+ output metrics.

This disclosure provides a method of adjusting a plurality of optical elements associated with a printing system LIM as a compensation strategy. This disclosure also provides an adjustment process where the number of adjustors is minimized.

### INCORPORATION BY REFERENCE

“CODE V” Introductory User's Guide by Optical Research Associates, Pasadena, Calif., copyright May 2008, 284 pages.

U.S. Patent Application Publication No. 2018/0196242, published Jul. 12, 2108 by Maeda et al. and entitled “Illumination Optical System for Laser Line Generator”;

U.S. Pat. No. 8,390,917, issued Mar. 5, 2013, by Maeda et al. and entitled “Multiple Line Single-Pass Imaging Using Spatial Light Modulator and Anamorphic Projection Optics”;

U.S. Pat. No. 8,472,104, issued Jun. 6, 2013, by Stowe et al. and entitled “Single-Pass Imaging System Using Spatial Light Modulator Anamorphic Projection Optics”;

U.S. Pat. No. 8,767,270, issued Jul. 1, 2014, by Curry et al. and entitled “Single-Pass Imaging Apparatus with Image Data Scrolling for Improved Resolution Contrast and Exposure Extent”;

U.S. Pat. No. 9,630,424, issued Apr. 25, 2017, by Stowe et al. and entitled “VCSEL-Based variable image optical line Generator,” are incorporated herein by reference in their entirety.

### BRIEF DESCRIPTION

In one embodiment of this disclosure, described is a method of adjusting a plurality of optical elements associated with a printing system LIM associated with a imaging surface comprising a) creating a computer model of the printing system LIM, the computer model including a plurality of input parameters associated with the optical and mechanical tolerances of the optical elements, and a plurality of output parameters associated with the performance of a beam associated with the printing system LIM; b) performing a sensitivity analysis of the computer model to determine an effect of the plurality of input parameters on each respective output parameter; c) performing a Monte Carlo simulation of the printing system LIM using the computer model to determine an alignment sequence of optical elements associated with selected input parameters to minimize the variability of output parameters associated with the performance of the printing system LIM, wherein the selected input parameters are selected as a function of maximum output parameter effect and one or more other constraints associated with the printing system LIM; and d) aligning the optical elements according to the alignment sequence to minimize the variability of output parameters associated with the printing system LIM.

In another embodiment of this disclosure, described is a computer readable program product, storing instructions that when executed by a computer, causes the computer to execute the instructions to perform a method of adjusting a plurality of optical elements associated with a printing system LIM associated with an imaging surface, the method comprising a) creating a computer model of the printing system LIM, the computer model including a plurality of input parameters associated with the optical and mechanical tolerances of the optical elements, and a plurality of output parameters associated with the performance of a beam associated with the printing system LIM; b) performing a sensitivity analysis of the computer model to determine an effect of the plurality of input parameters on each respective output parameter, c) performing a Monte Carlo simulation of the printing system LIM using the computer model to determine an alignment sequence of optical elements associated with selected input parameters to minimize the variability of output parameters associated with the performance of the printing system LIM, wherein the selected input parameters are selected as a function of maximum output parameter effect and one or more other constraints associated with the printing system LIM; and d) aligning the optical elements according to the alignment sequence to minimize the variability of output parameters associated with the printing system LIM.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates a method of adjusting a plurality of optical elements associated with a Laser Imaging Module in accordance with the present disclosure.

FIGS. 2A, 2B, and 2C are simplified side views of an exemplary

[symbol]

FIG. 4 illustrates a top view of the exemplary IBP of the LIM of FIG. 3.

FIG. 5 illustrates an exemplary printing system LIM including multiple IBPs.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/components/steps and permit the presence of other ingredients/components/steps. However, such description should be construed as also describing compositions, articles, or processes as “consisting of” and “consisting essentially of” the enumerated ingredients/components/steps, which allows the presence of only the named ingredients/components/steps, along with any impurities that might result therefrom, and excludes other ingredients/components/steps.

This disclosure provides an optimal compensation strategy for a LIM based image-marking system. In any optical system, there are numerous manufacturing tolerances that must be accommodated in any final design. An LIM generally is composed of multiple image beam paths (IBPs) butted together to create a substantially one-dimensional image on an imaging surface. Each LIM is intended to be the exposure means for a particular print station of a digital printing device, such as digital offset printing system (e.g., C, M, Y, K, etc.). That is, each IBP in a single LIM contributes to a particular width of a print station for one color in a multiple color printing system.

For a typical image beam path (IBP) of an LIM, there are 170+ different tolerances, and 20+ performance metrics. Via Monte Carlo simulation, a set of tolerances need to be developed which are capable of being met by a supplier, and a set of adjustments (with finite precision), such that all performance metrics are met at a specified Cpk level (e.g., 1.33). There are tradeoffs between the magnitude of the tolerances, the number and adjustability of the compensators, and the performance metric spec levels. Note that the compensation strategy development procedure is widely applicable to many different LIM systems, but will be described with reference to six (6) particular compensators specific to an exemplary IBP of an LIM with performance metric specs as described below. Note that minimization of adjustors reduces UMC and alignment labor costs.

There are 170+ optical/mechanical errors (tolerances) and 20+ well-defined output parameters with expected performance limits associated with each exemplary IBP of an LIM system described heretofore. Each projection optical system associated with an IBP includes at least five (5) optical elements. In some embodiments, each projection optical system associated with an IBP includes from 5 to 20 optical elements. In other embodiments, a projection optical system of an IBP is composed of 10 optical elements. Each optical component may have six positional degree of freedoms, i.e. translation and tilt in three dimensions, as well as many other constructional and optical degrees of freedom (such as index of refraction, x and y radii of curvature, thickness). This disclosure provides a LIM system with a minimum number of adjustors while maintaining the Cpk of the output parameters above 1.33.

In accordance with the present disclosure, a method of adjusting the optical elements associated with a printing system LIM is provided. The method serves to determine an alignment sequence for adjusting a plurality optical elements (“adjustors”). In some embodiments, the number of adjustors is less than the number of optical elements of the printing system. In other embodiments, the number of adjustors is less than the number of optical elements within a projection optical system of a printing system LIM. In still other embodiments, the number of adjustors is a predetermined number. In some exemplary embodiments, an LIM projection optics system with a minimum number of adjustors is disclosed. That is, in some embodiments, a minimum number of six (6) adjustors per image beam path are needed to maintain the Cpk of all 20+ output parameters above 1.33. Major contributors for each output parameter is identified using the sensitivity analysis tool provided by CODE V. As a compensation strategy, one can reduce the amount of variation in one or more contributors and/or use designated adjustors to reduce the variation in the outputs. The adjustor is selected by the amount of impact it incurs on the output and the availability in the mechanical design. A system model is created in CODE V and the latitude of the system is investigated with Monte Carlo simulations.

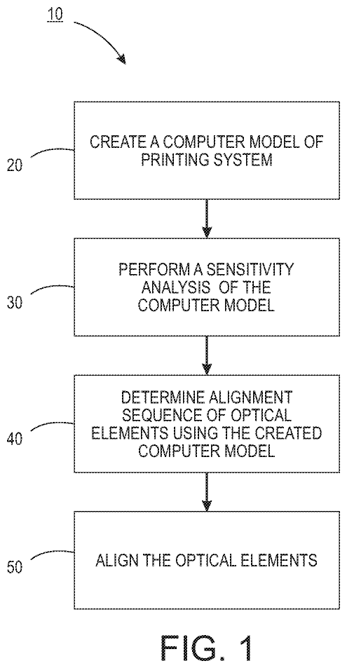

FIG. 1 illustrates a method 10 of adjusting a plurality of positional adjustors to adjust positions of a plurality of optical elements associated with an LIM. In some embodiments, the optical elements associated with the LIM include the projection optics system of the Laser Imaging Module (LIM) associated with an imaging surface.

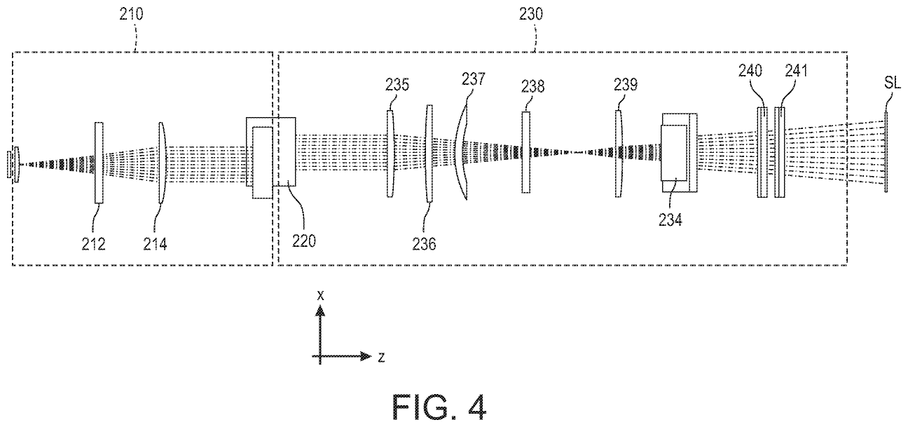

The method 10 includes creating 20 a computer model of a printing system. In some embodiments, the computer model includes a model of each optical element within the printing system, for example and without limitation, printing system 200 illustrated in FIGS. 3 and 4. In other embodiments, the computer model is a model of the optical elements of the projection optics system associated with each image beam path of a printing system, for example and without limitation, printing system 200. Each optical element is associated with a plurality of input parameters and output parameters associated with the performance of the printing system.

A sensitivity analysis is performed 30 on the created computer model. The sensitivity analysis determines the effect each input parameter has on each respective output parameter. The sensitivity analysis 30 may be performed in CODE V. The analysis 30 provides a first-order estimation of the impact of each DOF (degree of freedom) for each optical component on the output parameters.

An alignment sequence of optical elements is determined 40 using the created computer model. In some embodiments, the determining 40 is made by performing a Monte Carlo simulation of the printing system LIM using the created computer model. The simulation may be performed using selected input parameters of optical elements to optimize a plurality of output parameters associated with the performance of the printing system. After the alignment sequence is determined 40, optical elements may be aligned 50 according to the determined sequence.

With reference to FIGS. 3 and 4, an IBP of LIM system 200 with a minimum number of adjustors is shown. Each component and subsystem illustrated in FIGS. 3 and 4 have optical tolerances (fringe, thickness, refractive index, surface offset, and wedge), as well as mechanical tolerances (X-, Y-, Z-translations and tilts). Table 1, below, shows a sample of some of the tolerance types and values for Lens 1. Table 2 shows one exemplary example of a complete list of optical element tolerances associated with the projection optics portion of IBP of an LIM system. The tolerances can be modeled in many ways, such as Gaussian-distributed with a tolerance value at 2-sigma. Typical output parameters for each IBP in a LIM are given in Table 3.

TABLE 1
Optical tolerances for Lens 1

| | | | OM Tolerance |
|---|---|---|---|
| | | Tolerance | value |
| Element | Parameter | units | (+/−2 sigma) |
| Lens 1 | X-POSITION ERROR | mm | 0.257 |
| | Y-POSITION ERROR | mm | 0.234 |
| | Z-POSMON (AXIAL | mm | 0.001 |
| | POSITION) ERROR | | |
| | X-TILT ERROR | rad. | .014 |
| | Y-TILT ERROR | rad. | 0.007 |
| | Z-TILT (AXIAL | rad. | 0.00001 |
| | ROTATION) ERROR | | |
| | Convex Sphere | fr | 0.5 |
| | Plano | fr | 0.5 |
| | Wedge | mm | 0.0254 |
| | Refractive index | — | 0.001 |

TABLE 2
Inputs

| Element-Surface | input |
|---|---|
| RTIR | Δn |
| RTIR | Δn |
| RTIR | Δn |
| RTIR | Δn |
| RTIR | α tilt |
| RTIR | β tilt |
| RTIR | γ tilt |
| RTIR | Δx |
| RTIR | Δy |
| RTIR | Δz |
| RTIR-1 | power |
| RTIR-1 | irreg. 0 deg. |
| RTIR-1 | irreg. 45 deg. |
| RTIR-1 | α tilt |
| RTIR-1 | β tilt |
| RTIR-2 | power |
| RTIR-2 | irreg. 0 deg. |
| RTIR-2 | irreg. 45 deg. |
| RTIR-2 | Δz |
| RTIR-3 | power |
| RTIR-3 | irreg. 0 deg. |
| RTIR-3 | irreg. 45 deg. |
| RTIR-3 | α tilt |
| RTIR-3 | β tilt |
| L1 | Δn |
| L1 | α tilt |
| L1 | β tilt |
| L1 | γ tilt |
| L1 | Δx |
| L1 | Δy |
| L1 | Δz |
| L1-1 | irreg. 0 deg. |
| L1-1 | irreg. 45 deg. |
| L1-2 | irreg. 0 deg. |
| L1-2 | irreg. 45 deg. |
| L1-2 | TIR-α wedge |
| L1-2 | TIR-β wedge |
| L1-2 | γ tilt |
| L1-2 | Δx |
| L1-2 | Δy |
| L1-2 | Δz |
| L2 | Δn |
| L2 | α tilt |
| L2 | β tilt |
| L2 | γ tilt |
| L2 | Δx |
| L2 | Δy |
| L2 | Δz |
| L2-1 | irreg. 0 deg. |
| L2-1 | irreg. 45 deg. |
| L2-1 | TIR-α wedge |
| L2-1 | TIR-β wedge |
| L2-1 | γ tilt |
| L2-1 | Δx |
| L2-1 | Δy |
| L2-1 | Δz |
| L2-2 | irreg. 0 deg. |
| L2-2 | irreg. 45 deg. |
| L3 | Δn |
| L3 | α tilt |
| L3 | β tilt |
| L3 | γ tilt |
| L3 | Δx |
| L3 | Δy |
| L3 | Δz |
| L3-1 | irreg. 0 deg. |
| L3-1 | irreg. 45 deg. |
| L3-1 | TIR-α wedge |
| L3-1 | TIR-β wedge |
| L3-1 | γ tilt |
| L3-1 | Δx |
| L3-1 | Δy |
| L3-1 | Δz |
| L3-2 | irreg. 0 deg. |
| L3-2 | irreg. 45 deg. |
| L3-2 | Δx |
| L3-2 | Δy |
| L3-2 | γ tilt |
| L4 | Δn |
| L4 | α tilt |
| L4 | β tilt |
| L4 | γ tilt |
| L4 | Δx |
| L4 | Δy |
| L4 | Δz |
| L4-1 | irreg. 0 deg. |
| L4-1 | irreg. 45 deg. |
| L4-1 | TIR-α wedge |
| L4-1 | TIR-β wedge |
| L4-1 | γ tilt |
| L4-1 | Δx |
| L4-1 | Δy |
| L4-1 | Δz |
| L4-2 | irreg. 0 deg. |
| L4-2 | irreg. 45 deg. |
| L5 | Δn |
| L5 | α tilt |
| L5 | β tilt |
| L5 | γ tilt |
| L5 | Δx |
| L5 | Δy |
| L5 | Δz |
| L5-1 | irreg. 0 deg. |
| L5-1 | irreg. 45 deg. |
| L5-2 | irreg. 0 deg. |
| L5-2 | irreg. 45 deg. |
| L5-2 | TIR-α wedge |
| L5-2 | TIR-β wedge |
| L5-2 | γ tilt |
| L5-2 | Δx |
| L5-2 | Δy |
| L5-2 | Δz |
| M1 | power |
| M1 | irreg. 0 deg. |
| M1 | irreg. 45 deg. |
| M1 | α tilt |
| M1 | β tilt |
| M1 | Δz |
| M2 | power |
| M2 | irreg. 0 deg. |
| M2 | irreg. 45 deg. |
| M2 | α tilt |
| M2 | β tilt |
| M2 | Δz |
| L6 | Δn |
| L6 | α tilt |
| L6 | β tilt |
| L6 | γ tilt |
| L6 | Δx |
| L6 | Δy |
| L6 | Δz |
| L6-1 | irreg. 0 deg. |
| L6-1 | irreg. 45 deg. |
| L6-1 | TIR-α wedge |
| L6-1 | TIR-β wedge |
| L6-1 | γ tilt |
| L6-1 | Δx |
| L6-1 | Δy |
| L6-1 | Δz |
| L6-2 | irreg. 0 deg. |
| L6-2 | irreg. 45 deg. |
| EW | Δn |
| EW | α tilt |
| EW | β tilt |
| EW | γ tilt |
| EW | Δx |
| EW | Δy |
| EW | Δz |
| EW-1 | irreg. 0 deg. |
| EW-1 | irreg. 45 deg. |
| EW-2 | irreg. 0 deg. |
| EW-2 | irreg. 45 deg. |
| EW-2 | TIR-α wedge |
| EW-2 | TIR-β wedge |
| EW-2 | Δz |
| Image Plane | Δz |
| L1-1 | power-X |
| L1-1 | power-Y |
| L1-2 | power-X |
| L1-2 | power-Y |
| L2-1 | power-X |
| L2-1 | power-Y |
| L2-2 | power-X |
| L2-2 | power-Y |
| L3-1 | power-X |
| L3-1 | power-Y |
| L3-2 | power-X |
| L3-2 | power-Y |
| L4-1 | power-X |
| L4-1 | power-Y |
| L4-2 | power-X |
| L4-2 | power-Y |
| L5-1 | power-X |
| L5-1 | power-Y |
| L5-2 | power-X |
| L5-2 | power-Y |
| L6-1 | power-X |
| L6-1 | power-Y |
| L6-2 | power-X |
| L6-2 | power-Y |
| EW-1 | power-X |
| EW-1 | power-Y |
| EW-2 | power-X |
| EW-2 | power-Y |

TABLE 3
Output Metrics

| Metric | Units |
|---|---|
| Plane of Best Focus | mm |
| F1 cross process direction spot diameter | μm |
| F1 process direction spot diameter | μm |
| F2 cross process direction spot diameter | μm |
| F2 process direction spot diameter | μm |
| F3 cross process direction spot diameter | μm |
| F3 process direction spot diameter | μm |
| F4 cross process direction spot diameter | μm |
| F4 process direction spot diameter | μm |
| F5 cross process direction spot diameter | μm |
| F5 process direction spot diameter | μm |
| F6 cross process direction spot diameter | μm |
| F6 process direction spot diameter | μm |
| F7 cross process direction spot diameter | μm |
| F7 process direction spot diameter | μm |
| F8 cross process direction spot diameter | μm |
| F8 process direction spot diameter | μm |
| F9 cross process direction spot diameter | μm |
| F9 process direction spot diameter | μm |
| Cross Process boresight | μm |
| Cross Process mag | % |
| Cross Process Nonlinearity | μm |
| Skew | μm |
| Bow | μm |

A Monte Carlo simulation perturbs the nominal design with randomly selected values for the optical and mechanical errors for each optical element with an underlying assumption of the format of the distribution (for example, Gaussian) for each error. If one wishes, the probability function can be replaced with any common distribution (uniform, gamma . . . ) or a custom distribution. The output parameters of each perturbed case are evaluated and recorded. Histograms of each output parameters are plotted, and the mean and standard deviations can be readily calculated. A Monte Carlo simulation of 200 perturbed systems is generally enough to produce a good estimate of the statistics. A minimum number of six (6) adjustors per image beam path are identified to bring the output parameters within the spec limits, given the magnitudes of the other element tolerances. The process is facilitated by the sensitivity analysis in CODE V. It provides a first-order estimation of the impact of each DOF (degree of freedom) for each optical component on the output parameters. They are further confirmed by Monte Carlo simulations. With the alignment of the 6 adjustors, all output parameters now have Cpk's above 1.33. The minimum 6 adjustors are given as follows.

Mirror 1 alpha rotation
Lens 4 z shift
Lens 4 gamma rotation
Lens 1 z shift
Lens 1 gamma rotation
Lens 5 z shift

Described hereto is a LIM system with a minimum number of adjustors per image beam path. A minimum number of 6 adjustors are implemented to maintain the Cpk's of 20+ output parameters above 1.33.

Some benefits associated with the disclosed process are keeping the number of adjustors at a minimum means less cost on mechanical designing and tooling, and better efficiency in the alignment process, while the system is still robust to the optical and mechanical errors.

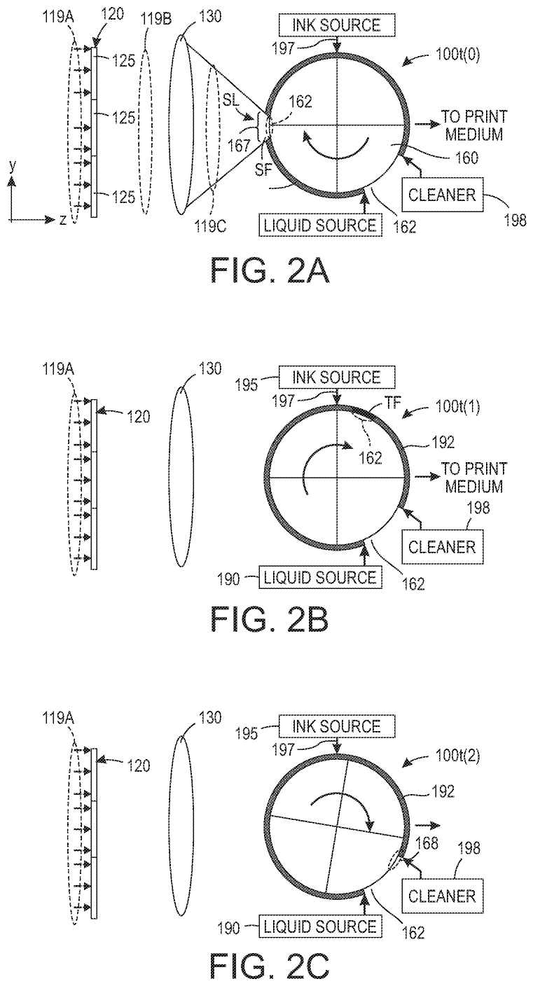

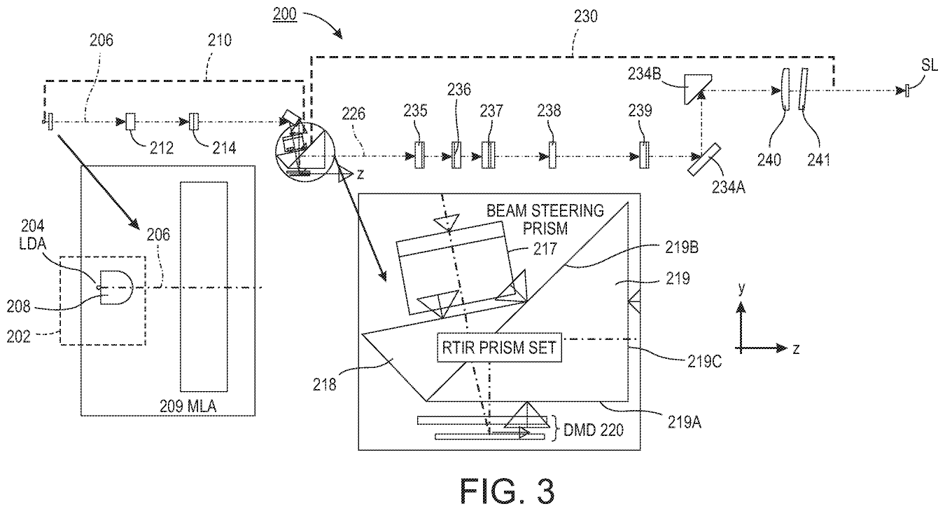

FIGS. 2A-2C show a simplified imagining apparatus 100 according to an embodiment of the present invention in which a LIM is incorporated into a printer, such as a digital offset printer, including a plurality of optical elements. FIGS. 2A-2C illustrate an LIM with a single IBP. Digital offset printing processes may include applying a fountain solution to a surface of an imaging plate. The imaging plate may be arranged on an outer portion of an imaging cylinder. The imaging cylinder may be rotatable for bringing regions of the imaging plate surface to pass adjacent subsystems, including a dampener for applying fountain solution; an imaging system including an LIM for imaging or image wise-vaporization of fountain solution from select regions of the imaging plate, an inker for applying ink to the imaging plate surface; a transfer station from which an ink image is transferred to a printable medium; and a cleaner for removing residue from a surface of the image plate and preparing the surface to begin the process anew.

After applying the fountain solution, an imaging system composed of a high power laser is used to image-wise vaporize fountain solution from select regions of the surface. Light energy is absorbed by the imaging plate, which may comprise silicone, to locally heat and boil off fountain solution from the plate surface. The laser may be used for vaporizing the fountain solution at select surface regions in accordance with digital image data. For the imaging step, an LIM system may be used that is configured to produce an output beam that spans the operative width of an imaging plate surface. A resulting image is transferred at a transfer station to paper or other suitable media.

FIGS. 2A-2C are provided for showing a context of the present disclosure. The apparatus utilizes an image transfer operation in which a fountain solution is selectively removed by concentrated laser light prior to the application of an ink, which is then transferred to a print medium (e.g. a sheet of paper). The illustrated arrangement shown in FIGS. 2A-2C is intended to very generally describe an image transfer operation with the use of an LIM, and those skilled in the art will recognize that the basic concept of the image transfer operation may be implemented using arrangements other than those described herein. Those skilled in the art will recognize that the phrase “fountain solution” refers to a dampening (e.g., water, Novec™ manufactured by 3M of St. Paul, Minn., USA, etc.) solution used in lithography to keep non-image areas of smooth imaging surface (e.g., a plate or roller surface) from holding ink.

FIGS. 2A-2C illustrate an image transfer operation of imaging apparatus 100 in that these figures show the substantially instantaneously and complete removal of fountain solution 192 when exposed to concentrated light. FIG. 2A shows imaging apparatus 100 at an initial time t0, FIG. 2B shows imaging apparatus 100 at a subsequent time t1, and FIG. 2C shows imaging apparatus 100 at a further subsequent time t2.

Referring to FIG. 2A, to implement the image transfer operation, imaging apparatus 100 further includes a liquid source 190 that applies a fountain solution 192 onto imaging surface 162 at a point upstream of elongated imaging region 167, an ink source 195 that applies an ink material 197 at a point downstream of elongated imaging region 167, a transfer mechanism (not shown) for transferring the ink material 197 to a target print medium, and a cleaning mechanism 198 that prepares imaging surface 162 for the next exposure cycle. Ink source 195 applies ink material 197 onto exposed portions of imaging surface 162 (i.e., when fountain solution 192 is removed to expose such portions). According to the image transfer operation, only ink material disposed on imaging surface 162 is transferred to the print medium. Thus, variable data from fountain solution removal is transferred, instead of constant data from a plate as in conventional systems.

At time t0 (FIG. 2A) a homogenous light field 119A generated by a light source passing through an illumination optical system (See FIG. 3, 210), is introduced to a spatial light modulator 120 (e.g. a digital micro-mirror device) including a plurality of light modulating elements 125. A portion of the homogenous light field 119A is received by these elements and passed into modulated light field 119B where the light is concentrated through a plurality of optical elements, generally represented by projection optical system 130, and described in more detail with respect to FIG. 3.

The projection optical system 130 is represented for the purposes of simplification in FIGS. 2A-2C by a single generalized anamorphic projection lens. In practice, the projection optical system 130 is typically composed of multiple separate cylindrical or acylindrical lenses and mirrors such as those described below with reference to FIG. 3 and is not limited to the generalized lens or specific lens systems described herein.

Light is allowed to pass through the spatial light modulator 120 when at least one of the modulating elements 125 is in an “on” modulated state. The light field 119A is concentrated by the optical system 130 such that the imaged and concentrated light field 119C applies light onto the portion of the elongated imaging region 167 corresponding to a substantially one-dimensional scan line portion SL. In this embodiment, the concentrated light field 119C substantially instantaneously and completely removes the fountain solution disposed over surface region 162, thereby forming surface feature SF that exposes imaging surface region 162. Note that prior to time two t2, the modulating elements 125 of spatial light modulator 120 are maintained in an “off” modulated state such that all portions of imaging surface located downstream of surface region 162 remain covered with fountain solution 192 that repels or rejects ink material 197.

FIGS. 2B and 2C show how surface feature SF is subsequently utilized in accordance with the image transfer operation of imaging apparatus 100. Referring to FIG. 2B, at time t1 drum cylinder 160 has rotated such that surface region 162 has passed under ink source 195. Due to the removal of fountain solution depicted in FIG. 2A, ink material 197 is disposed on exposed surface region 162 to form an ink feature TF. As ink feature TF passes the transfer point, ink feature TF is transferred to a print medium, resulting in ink being printed on the print medium. Subsequently, as indicated in FIG. 2C, the surface region 162 with ink feature TF now substantially removed is rotated under cleaning mechanism 198, which removes any residual ink and fountain solution material to prepare surface region 162 for a subsequent exposure/print cycle.

FIG. 3 represents a side view of a single image beam path (IBP) of an LIM system 200 according to the concepts of the present application. Generally, the IBP of the LIM system can be described as including a light source 202, an illumination optical system 210, a spatial light modulator (SLM) 220, and a projection optical system 230.

The illumination optical system 210 includes a plurality of optical elements to ensure uniform illumination of the SLM 220. The SLM 220 selectively passes light to the projection optical system 230 that images and concentrates the modulated light to an image-receiving surface (“imaging surface”).

Initially, an independently addressable laser array 204, such as a laser diode array (LDA), which includes a plurality of beam-generating elements, emits beams 206, defined as a group, to pass through a FAC lens 208. Beams 206 then pass through at least one optical element within the illumination optical system 210. In some embodiments, the illumination optical system may include a microlens array 209 and plurality of optical lenses, mirrors and prisms. In some embodiments, the illumination optical system includes optical lenses 212 and 214, mirrors 216, and beam steering prism 217. The lenses may be convex, concave, plano, spherical, aspherical, cylindrical, acylindrical, any combination of shapes or lenses shaped as needed to direct and focus the light beans to the SLM 220. The lenses may be made of materials and processes known in the art. It is to be appreciated that the disclosure is not limited to the optical elements described and that other optical elements such as beam mixing optics, prisms, mirrors, or other optical elements known in the art may be used within the illumination optical system 210. The illumination optical system 210 causes beams 206 to uniformly impinge on the SLM 220.

The beams 206 then pass through a set of reverse total internal reflection (RTIR) prisms 218 and 219. The RTIR prisms 218 and 219 direct the beams 206 along a compound incident angle to illuminate the SLM 220. The prisms then receive and project the modulated light beams 226 passed from the SLM 220. That is, compound angle prism 218 is part of the illumination optical system 210. The compound angle prism 218 has a bottom face above a top face of the 45-45-90 degree prism 219 with an airspace therebetween. The SLM array 220 modulates the light beam 206 directed to the SLM 220 from the compound prism 218 and generates an image as reflected image output beams. The reflected image beams enter the 45-45-90 degree prism 219 that directs the modulated light beams 226 along the projection optical system 230 that images the SLM onto an imaging surface as a scan line SL.

The 45-45-90 prism 219 is part of the projection optical system 230 and includes entrance face 219A (RTIR-1), reflection face 219B (RTIR-2) and exit face 219C (RTIR-3). Modulated light beams 226 enter the prism 219 from the SLM 220 at entrance face 219A. The modulated light beams 226 internally reflect from the reflection face 219B and exit out of exit face 219C toward the collimating lens 235.

In some embodiments, the spatial light modulator 220 is a digital micromirror device (DMD). The DMD includes an array of thousands to millions of micromirrors arranged on a chip substrate. The mircomirrors rapidly switch to create a plurality of projected pixels. One such DMD device is the DLP4501 available through Texas Instruments®. The DMD may be a digitally controlled micro-opto-electromechanical system (MOEMS) spatial light modulator.

Referring to the right portion of FIG. 3, the projection optical system 230 serves to anamorphically image and concentrate (focus) the two-dimensional modulated light field 119B, composed of beams 226 onto the elongated imaging region of imaging surface 162. In particular, the projection optical system 230 includes one or more optical elements (e.g., lenses, mirrors, and or prisms) that are positioned to receive the two-dimensional pattern of modulated light field 119b (modulated beam 226). The one or more optical elements (e.g., lenses, mirrors, prisms) are arranged to concentrate the received light portions to a greater degree along the process (e.g., Y-axis) direction than along the cross-process (X-axis) direction, whereby the received light portions are anamorphically focused to form elongated scan line image SL that extends parallel to the cross-process/scan (X-axis) direction.

The projection optical system 230, according to an exemplary embodiment, includes the RITR prism 219, a cross-process optical subsystem, a process-direction optical subsystem and an exit window 241. As indicated by the ray traces in FIGS. 3 and 4, the optical subsystems are disposed in the optical path between the spatial light modulator 220 and scan line SL. FIG. 4 is a top view indicating that the elements of the cross-process optical subsystem (described in greater detail below) acts on the modulated light passed by the SLM 220 to form concentrated light portions on scan line SL parallel to the x-axis. FIG. 3 is a side view that indicates how the subsystems act on modulated light and generate concentrated light portions on scan line SL in a direction perpendicular to the y-axis.

The cross-process optical subsystem is a system of at least two optical elements. The cross-process optical system magnifies light in the cross-process (scan) direction (i.e. along the x-axis). This allows the intensity of the light (e.g. laser) power to be concentrated on the SL located at the output of a single-pass imaging system. The multi-lens subsystem may include cylindrical or acylindrical lenses that are arranged to project and magnify modulated light portions (imaging data) passed by spatial light modulator 220 and through the exit window 241 that ultimately impinges an image to an imaging surface (e.g., a cylinder) in the cross-process-direction. In some embodiments and as shown in FIGS. 3 and 4, the cross-process optical subsystem includes a collimating optical lens 235 (L1) and projection lenses 236 (L2), 237 (L3), and 239 (L5). The collimating optical lens 235 is located immediately after the spatial light modulator 220 and is arranged to collimate the light beam portions that are slightly diverging off of the surface of the spatial light modulator 220. The lenses of the cross-process optical system are formed in accordance with known techniques. The process-direction optical subsystem includes at least one optical element that focuses light in the y-direction. In some embodiments, the process-direction optical subsystem may include cylindrical and/or acylindrical lenses. This subsystem allows the intensity of the light (e.g., laser) power to be concentrated on scan line SL located at the output of LIM system 200. That is, it concentrates the projected imaging data down to a narrow high-resolution line image on scan line SL. In some embodiments, the cross-process-direction optical system includes projection lenses 238 (L4) and 240 (L6).

The exit window 241 of the projection optical system 230 is used to isolate and protect the rest of the optical elements from the external environment. In some embodiments, the exit window 241 is an elongated (in the cross-process direction) piece of flat glass. In other embodiments, the exit window may include an elongated (in the cross-process direction) lens.

In some embodiments, the system includes a pair of projection mirrors 234A (M1) and 234B (M2). The pair of projection mirrors 234A and 234B direct/tilt the beams toward a plane level with the desired scan line SL. This may include a set of mirrors that shift the light beams along the y-axis.

The details of FIGS. 3 and 4 are intended to illustrate a single IBP of an LIM system 200 that incorporates concepts of the present application. However, it is to be understood that such concepts may also be used in multiple-beam systems of other designs. Further, while the present concepts may be applied to systems with as few as one, presently, multiple IBP LIM systems have been developed which include 2 to 30 IBPs, and the present concepts are applicable to these systems. In some embodiments, the LIM includes 15 IBPs.

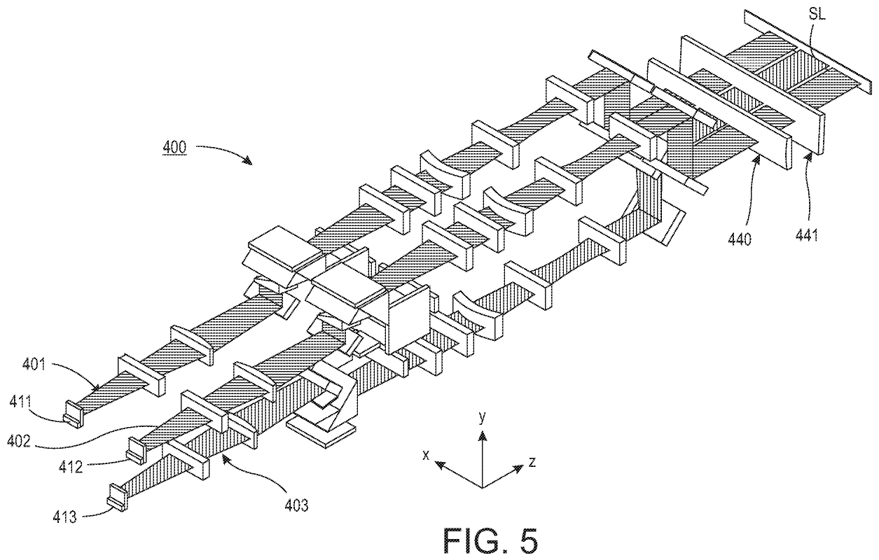

FIG. 5 illustrates an exemplary digital offset printing system LIM 400 including more than one IBPs. Three IMPs 401, 402, and 403 are shown. It is to be appreciated that each IBP is associated with its own light source 411, 412, 413 each generating beam along paths 401, 402, and 403, respectively. Each IBP 401, 402, and 403 may be similar to the single IBP described in FIGS. 3 and 4, that is, each IBP may include a light source, an illumination optical system, a SLM, projection optical system, and exit window.

In some embodiments, the digital offset printing system may include shared optical elements. That is, rather than each IBP having its own set of optical elements as is shown with respect to FIGS. 3 and 4, some optical elements may span the entire x-direction of the combined beams 411, 412, and 413 such that all beam paths pass through the same process-direction optical elements. In some embodiments, the IBP's may share a single exit window 441. In some embodiments, the IBP's 401, 402, and 403 may share a common component of the cross-process-direction optical system, for example and without limitation, the IBP's 401, 402, and 403 may share projection lens 440. The LIM may include 3 to 30 IBPs including 15 IBPs.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art, which are also intended to be encompassed by the following claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A method of adjusting a plurality of positional adjustors to adjust positions of a plurality of optical elements associated with the projection optics system of a printing system Laser Imaging Module (LIM) associated with an imaging surface, comprising:
a) creating a computer model of the printing system LIM, the computer model including a plurality of input parameters associated with the optical and mechanical tolerances of the optical elements, and a plurality of output parameters associated with the performance of a beam associated with the printing system LIM;
b) performing a sensitivity analysis of the computer model to determine an effect of the plurality of input parameters on each respective output parameter;
c) performing a Monte Carlo simulation of the printing system LIM using the computer model to determine an alignment sequence of optical elements associated with selected input parameters to optimize the plurality of output parameters associated with the performance of the printing system LIM, wherein the selected input parameters are selected as a function of maximum output parameter effect and one or more other constraints associated with the printing system LIM; and
d) aligning the optical elements according to the alignment sequence to optimize the plurality of output parameters associated with the projection optics system of the printing system LIM.

2. The method according to claim 1, wherein step a) creates a computer model of the printing system LIM using CODE V.

3. The method according to claim 1, wherein the optical elements include 5 to 20 optical elements, wherein each optical element within plurality of the optical elements has six positional degrees of freedom.

4. The method according to claim 1, wherein the alignment sequence minimizes the number of optical elements needed to be adjusted to achieve a targeted Cpk of the output parameters above a certain minimum value.

5. The method according to claim 4, wherein the targeted Cpk is in the range of 1 to 5.

6. The method according to claim 1, wherein the optical elements include one or more of, a collimator, one or more lenses, one or more mirrors, a spatial light modulator, a reverse total internal reflection prism and exit window.

7. The method according to claim 1, wherein the optical elements are configured such that a light propagates through six (6) lenses and two (2) mirrors before the light impinges on the imaging surface as a substantially one-dimensional scan line.

8. The method according to claim 1, wherein the output parameters include one or more of bow, skew, cross-process nonlinearity, cross process magnification, cross-process boresight, and spot diameter, associated with the printing system LIM.

9. The method according to claim 1, wherein the printing system LIM includes one adjustor per output parameter.

10. The method according to claim 1, wherein the input parameters include one or more positional degrees of freedom associated with each optical element and one or more constructional tolerances associated with each optical element.

11. The method according to claim 1, wherein the LIM comprises 3 to 30 image beam paths, wherein each image beam path is associated with a projection optical system.

12. The method according to claim 11, wherein the 3 to 30 image beam paths share at least one optical element of a process-direction optical subsystem.

13. The method according to claim 11, wherein the 3 to 30 image beam paths share an exit window.

14. The method according to claim 1, wherein the LIM comprises at least fifteen (15) image beam paths, wherein each image beam path comprises a projection optical system.

15. A computer readable program product, storing instructions that when executed by a computer, causes the computer to execute the instructions to perform a method of adjusting a plurality of optical elements associated with a projection optics system of a printing system LIM associated with an imaging surface, the method comprising:
a) creating a computer model of the printing system LIM, the computer model including a plurality of input parameters associated with the optical and mechanical tolerances of the optical elements, and a plurality of output parameters associated with the performance of a beam associated with the projection optics system;
b) performing a sensitivity analysis of the computer model to determine an effect of the plurality of input parameters on each respective output parameter;
c) performing a Monte Carlo simulation of the printing system LIM using the computer model to determine an alignment sequence of optical elements associated with selected input parameters to optimize the plurality of output parameters associated with the performance of the printing system LIM, wherein the selected input parameters are selected as a function of maximum output parameter effect and one or more other constraints associated with the projection optics system; and
c) aligning the optical elements according to the alignment sequence to optimize the plurality of output parameters associated with the projection optics system.

16. The computer program product according to claim 15, wherein step a) creates a computer model of the printing system LIM using CODE V.

17. The computer program product according to claim 15, wherein the alignment sequence minimizes the number of optical elements needed to be adjusted to achieve a targeted Cpk of the output parameters above a certain minimum value.

18. The computer program product according to claim 15, wherein the optical elements include one or more of a collimator, one or more lenses, one or more mirrors, a spatial light modulator, a reverse total internal reflection prism and exit window.

19. The computer program product according to claim 15, wherein the optical elements are configured such that a light propagates through at least six (6) lenses and two (2) mirrors before the light impinges on the imaging surface as a substantially one-dimensional scan line

20. The computer program product according to claim 15, wherein the output parameters include one or more of bow, skew, cross-process nonlinearity, cross process magnification, cross-process boresight, and spot diameter, associated with the printing system LIM.

21. The computer program product according to claim 15, wherein the printing system LIM includes one adjustor per output parameter.

22. The computer program product according to claim 15, wherein the input parameters include one or more positional degrees of freedom associated with each optical element and one or more constructional tolerances associated with each optical element.

23. The computer program product according to claim 15, wherein the LIM comprises at least three (3) image beam paths, each image beam path associated with a projection optics system.

25. The computer program product according to claim 15, wherein the LIM comprises fifteen (15) image beam paths, each image beam path associated with a projection optics system.
